(19) United States
(12) Patent Application Publication
(10) Pub. No.: US 2025/0137965 A1
(43) Pub. Date: May 1, 2025

(54) ELECTROPHORESIS DEVICE

(71) Applicant: HITACHI HIGH-TECH CORPORATION, Tokyo (JP)

(72) Inventor: Hitoshi Miyata, Tokyo (JP)

(73) Assignee: HITACHI HIGH-TECH CORPORATION, Tokyo (JP)

(21) Appl. No.: 18/836,691

(22) PCT Filed: Feb. 15, 2022
(86) PCT No.: PCT/JP2022/005864

§ 371 Date: Aug. 7, 2024

(51) Int. Cl. G01N 27/447

(52) U.S. Cl. CPC G01N 27/44721; G01N 27/44791

(57) ABSTRACT

In order to provide an electrophoresis device requiring no realignment of the optical axis of excitation light with the capillary array even if the outer diameter of the capillary may change, the electrophoresis device includes: a capillary array including a planar arrangement of capillaries used for electrophoresis of a sample; an excitation light source that applies excitation light along an arrangement direction of the capillaries; a fluorescence measuring unit that measures fluorescence induced from the capillary array; a reference member on which the capillary array is arranged; and a capillary mounting stand having a window through which the excitation light passes, and being to be abutted against the reference member. The reference member has a step that is set based on outer diameters of the capillaries.

### TECHNICAL FIELD

The present invention relates to an electrophoresis device that separates and analyzes samples such as DNA.

### BACKGROUND ART

The electrophoresis device separates a fluorescently labeled sample by electrophoresis, and analyzes the sample by detecting fluorescence induced by irradiation of excitation light. In particular, when a small amount of sample such as DNA is analyzed, the sample, which has been packed together with a separation medium in a capillary made of quartz glass, is separated by electrophoresis. Throughput is improved by arranging the capillaries planarly to analyze multiple samples simultaneously.

Patent literature 1 discloses that, to simultaneously detect fluorescence emitted by samples in a capillary array including a planar arrangement of capillaries, the samples are irradiated with excitation light along an arrangement direction of the capillaries to detect fluorescence emitted in a direction perpendicular to the arrangement plane. In particular, a relationship between a size of the capillary with a circular cross section and a refractive index of each part is disclosed to allow efficient irradiation of the excitation light to the capillary array.

### CITATION LIST

### Patent Literature

Patent Literature 1: Japanese Patent No. 3654290

### SUMMARY OF INVENTION

### Technical Problem

However, the patent literature 1 has no consideration for alignment of an optical axis of the excitation light with the capillary array. The outer diameter of the capillary is determined according to the number of arrangements and a type of the separation medium, and a change in outer diameter of the capillary requires realignment of the optical axis of the excitation light with the capillary array. Since alignment of the optical axis with the capillary array requires an accuracy of several micrometers and a great deal of man-hours, the need for realignment is desirably eliminated.

An object of the present invention is therefore to provide an electrophoresis device requiring no realignment of the optical axis of excitation light with the capillary array, even if the outer diameter of the capillary may change.

### Solution to Problem

In order to achieve the above object, an electrophoresis device of the present invention includes: a capillary array including a planar arrangement of capillaries used for electrophoresis of a sample; an excitation light source that applies excitation light along an arrangement direction of the capillaries; and a fluorescence measuring unit that measures fluorescence induced from the capillary array. The electrophoresis device further includes: a reference member on which the capillary array is arranged; and a capillary mounting stand having a window through which the excitation light passes, and being to be abutted against the reference member. The reference member has a step that is set based on outer diameters of the capillaries.

### Advantageous Effects of Invention

According to the present invention, it is possible to provide an electrophoresis device requiring no realignment of the optical axis of excitation light with the capillary array, even if the outer diameter of the capillary may change.

### BRIEF DESCRIPTION OF DRAWINGS

FIG. 1 shows an exemplary overall configuration of an electrophoretic device according to a first embodiment.

FIG. 2 includes diagrams showing an exemplary overall configuration of a capillary array.

FIG. 3 shows an exemplary configuration of a capillary mounting stand.

FIG. 4 shows exemplary dimensions of the capillary mounting stand and a reference member.

### DESCRIPTION OF EMBODIMENTS

Hereinafter, one preferred embodiment of an electrophoretic device according to the invention will be described with reference to the accompanying drawings. The electrophoresis device separates a fluorescently-labeled sample by electrophoresis, and analyzes the sample by detecting fluorescence induced by irradiating the sample with excitation light.

### First Embodiment

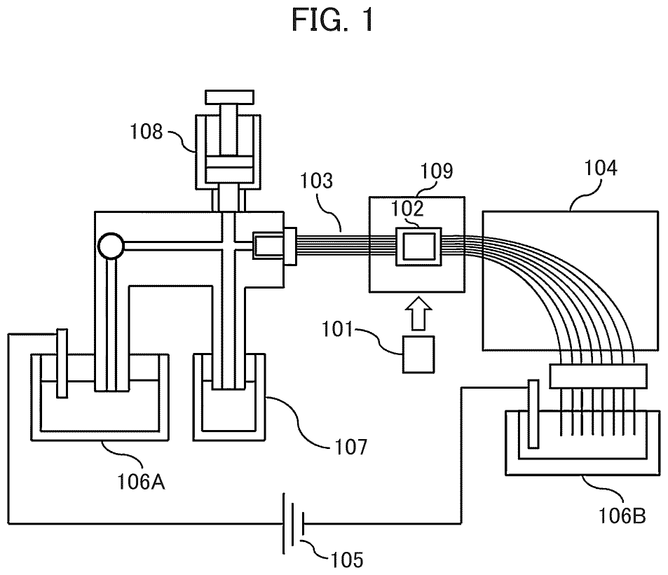

An exemplary overall configuration of the electrophoretic device of a first embodiment is described with reference to FIG. 1. The electrophoresis device includes an excitation light source 101, a fluorescence measuring unit 102, a capillary array 103, a thermostatic oven 104, a voltage source 105, an anode buffer solution container 106A, a cathode buffer solution container 106B, a separation medium container 107, a pump 108, and a capillary mounting stand 109. Each of such components is described below.

The excitation light source 101 is a device to apply excitation light to the capillary array 103, for example, a laser light source. The excitation light is applied along an arrangement direction of the capillary array 103.

The fluorescence measuring unit 102 is a device that measures fluorescence induced in the capillary array 103 by irradiation of excitation light, and is, for example, a CCD camera. The fluorescence measuring unit 102 is disposed in a direction perpendicular to the arrangement plane of the capillary array 103.

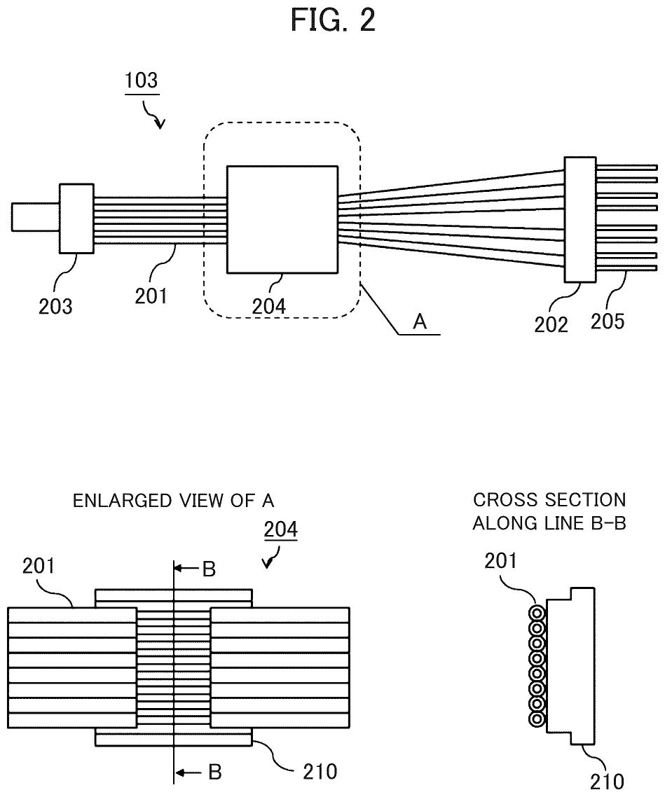

The capillary array 103, including arrangement of capillaries to be used for electrophoresis of a sample, is replaced as necessary. A configuration of the capillary array 103 is described with reference to FIG. 2. The capillary array 103 includes a plurality of capillaries 201, a load header 202, a capillary head 203, and a detection unit 204.

The capillary 201 is a capillary tube used for electrophoresis of the sample, and includes, for example, a glass tube, which has an inner diameter of several tens to several hundreds of micrometers and an outer diameter of several hundreds of micrometers, with an outer surface coated with polyimide of several tens of micrometers in thickness for reinforcement. The capillary 201 is filled with a separation medium, which is an electrolyte solution, together with the sample. The separation medium may contain a polymer gel, a polymer, and the like.

The load header 202 is a resin member with hollow electrodes 205 that are each a hollow member made of metal. The hollow electrodes 205 and the capillaries 201 have the same number and have fixed together with an adhesive or the like while one end of each capillary 201 is inserted through one hollow electrode 205. The capillary head 203 is a resin member to bundle the other ends of the capillaries 201 together.

At the detection unit 204, excitation light is applied from the excitation light source 101, and fluorescence is measured by the fluorescence measuring unit 102. In the detection unit 204, the polyimide on the outer surface of the capillary 201 is removed so as not to hinder irradiation of excitation light and measurement of fluorescence. In the detection unit 204, a reference member 210 is disposed, and the capillaries 201 are arranged planarly on the reference member 210. The reference member 210 has a step on either end in the arrangement direction of the capillaries 201.

Returning to description of FIG. 1. The thermostatic oven 104 is a temperature regulator to keep the capillary array 103 at a predetermined temperature. The voltage source 105 is a power supply that applies a voltage to the two ends of the capillary array 103, and has an anode connected to the capillary array 103 on the capillary head 203 side and a cathode connected thereto on the load header 202 side. The anode buffer solution container 106A and the cathode buffer solution container 106B each contain a buffer solution to supply electric charges during electrophoresis, where the anode buffer solution container 106A is disposed on the capillary head 203 side, and the cathode buffer solution container 106B is disposed on the load header 202 side. The separation medium container 107 contains the separation medium. The pump 108 is used to inject the separation medium into the capillary 201.

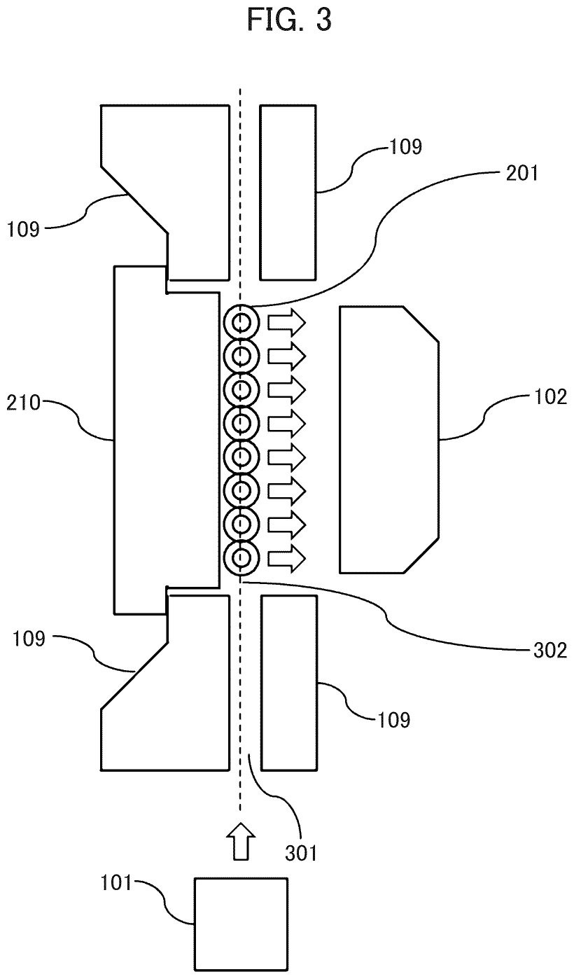

The capillary mounting stand 109, on which the detection unit 204 of the capillary array 103 is mounted, is fixed to a housing of the electrophoresis device. A configuration of the capillary mounting stand 109 is described with reference to FIG. 3. The capillary mounting stand 109 has a window 301, through which the excitation light emitted from the excitation light source 101 passes, and is abutted against the reference member 210 on which the capillaries 201 are arranged. The capillary array 103 may be integrated with the reference member 210 so as to be replaced together with the reference member 210 as necessary. Integrating the capillary array 103 with the reference member 210 makes it possible to reduce man-hours required to replace the capillary array 103.

The window 301 is aligned with an optical axis 302 of the excitation light emitted from the excitation light source 101. Specifically, the window 301 is provided in the capillary mounting stand 109 so that its center coincides with the optical axis 302. The reference member 210 has the steps on the two ends in the arrangement direction of the capillaries 201 so that the capillaries 201 are positioned appropriately with respect to the optical axis 302 when the reference member 210 is abutted against the capillary mounting stand 109. FIG. 3 shows a state where the reference member 210 is abutted against the capillary mounting stand 109 so that the center of each capillary 201 is disposed at the position of the optical axis 302 located at the center of the window 301. The steps are appropriately set based on the outer diameter of the capillary 201.

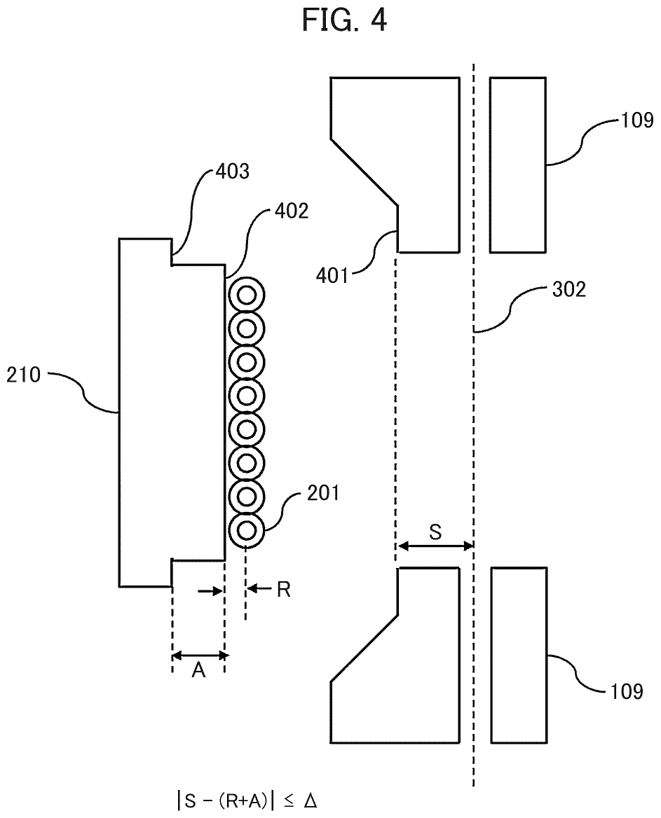

Dimensions of the capillary mounting stand 109 and the reference member 210 are described in more detail with reference to FIG. 4. The capillary mounting stand 109 has a contact surface 401 which is to be in contact with the reference member 210, and S represents a distance from the contact surface 401 to the optical axis 302. The reference member 210 has a step A including an upper surface 402 and a lower surface 403, where the capillaries 201 are arranged planarly on the upper surface 402, while the lower surface 403 is in contact with the contact surface 401.

When the capillary 201 has an outer diameter of 2R, the step A is set so that the absolute value |S−(R+A)| of the difference between the distance S and the sum (R+A) of half R of the outer diameter and the step A is less than or equal to a predetermined threshold Δ. Most preferably, the threshold Δ is zero, i.e., the distance S is equal to the sum (R+A). However, the threshold Δ may be determined based on the outer diameter 2R, the inner diameter 2r, and the refractive index n_c of the capillary 201, the refractive index n_o of the medium outside the capillary 201, and the refractive index n_o of the medium inside the capillary 201 so that the capillary array 103 is efficiently irradiated with the excitation light. The threshold Δ is determined based on the outer diameter 2R and inner diameter 2r of the capillary 201 and the respective refractive indices n_c, n_o, and n_o, making it possible to reduce the number of man-hours required to process the reference member 210 and others while maintaining efficient irradiation of excitation light.

The error between the optical axis of the excitation light and the center of the capillary 201 is desirably within ±8 μm. The tolerance of the outer diameter of the capillary 201 is in general roughly ±5 μm. When the upper surface 402 and the lower surface 403 are each produced with a flatness of 1 μm, the tolerance of the step A of the reference member 210 should be ±4.5 μm (=8 μm−2.5 μm−0.5 μm−0.5 μm) or less. The error in the outer diameter of the capillary 201 is specified to be 2.5 μm, which is half the tolerance of 5 μm, and the error in each of the upper and lower surfaces 402 and 403 is specified to be 0.5 μm, which is half the flatness of 1 μm. The reference member 210 is manufactured by high-precision machining with an accuracy of 1 μm, which makes it possible to adjust the tolerance of the step A to 4.5 μm or less.

Hereinbefore, one embodiment of the invention has been described. The invention should not be limited thereto, and each component may be modified without departing from the gist of the invention. The plurality of components disclosed in the embodiment may be combined as appropriate. Furthermore, some of the components shown in the embodiment may be deleted.

### REFERENCE SIGN LIST

101: excitation light source
102: fluorescence measuring unit
103: capillary array
104: thermostatic oven
105: voltage source
106A: anode buffer solution container
106B: cathode buffer solution container
107: separation medium container
108: pump
109: capillary mounting stand
201: capillary
202: load header
203: capillary head
204: detection unit
205: hollow electrode
210: reference member
301: window
302: optical axis
401: contact surface
402: upper surface
403: lower surface

1. An electrophoresis device, comprising:
a capillary array including a planar arrangement of capillaries used for electrophoresis of a sample;
an excitation light source that applies excitation light along an arrangement direction of the capillaries; and
a fluorescence measuring unit that measures fluorescence induced from the capillary array,
the electrophoresis device, further comprising:
a reference member on which the capillary array is arranged; and
a capillary mounting stand having a window arranged so that a center thereof coincides with an optical axis of the excitation light emitted along the arrangement direction of the capillaries, the capillary mounting stand being abutted against the reference member,
wherein
the reference member has a step including an upper surface where the capillaries are arranged and a lower surface that is in contact with the capillary mounting stand, and
an absolute value |S−(R+A)| of a difference between a distance S from a contact surface of the capillary mounting stand to an optical axis of the excitation light, the contact surface being to be in contact with the reference member, and the sum (R+A) of half R of the outer diameter of the capillary and the step A is less than or equal to a predetermined threshold.

2. (canceled)

3. The electrophoresis device according to claim 1, wherein
the threshold is determined based on the outer diameter, an inner diameter, and a refractive index of the capillary, and a refractive index of each of media outside and inside the capillary.

4. The electrophoresis device according to claim 1, wherein
the threshold is zero.

5. The electrophoresis device according to claim 1, wherein
the capillary array is integrated with the reference member, and is replaced together with the reference member.
